(19) United States
(12) Patent Application Publication
(10) Pub. No.: US 2012/0254150 A1
(43) Pub. Date: Oct. 4, 2012

(54) DYNAMIC ARRANGEMENT OF E-CIRCULARS IN RAIS (RICH ADS IN SEARCH) ADVERTISEMENTS BASED ON REAL TIME AND PAST USER ACTIVITY

(75) Inventor: Arpit Gupta, New Delhi (IN)

(73) Assignee: Yahoo! Inc, Sunnyvale, CA (US)

(21) Appl. No.: 13/078,002

(22) Filed: Apr. 1, 2011

(51) Int. Cl. G06F 17/30

(52) U.S. Cl. 707/709; 707/E17.108

(57) ABSTRACT

A first advertisement and a second advertisement are served responsive to a search query. User interactions with the query results, such as with the first advertisement, are detected and used as inputs to selecting at least a portion of the second advertisement. User actions can include a hover, a selection, a button selection, or the like.

### BACKGROUND

1. Technical Field

Embodiments of the invention relate generally to online advertisements, and more specifically, dynamic listings in RAIS (Rich Ads In Search).

2. Prior Art

Online advertising provides an alternative medium for advertisers to reach potential customers. Besides just making impressions which display an advertisement to customers, advertisers seek actual click-through rates to show that a user is paying attention to a particular advertisement. One current technique of improving click-through rates is to embed advertisements within search results. For example, a search for ‘dog walking’ as a query can lead to dog food or veterinarian advertisements. In essence, the search query is used to determine a user's interest.

However, current techniques limit advertisement selection to the query. Result pages for searches have more than just hyperlinks to web pages. Besides advertisements, the results pages can also include previews to a web page and other features that can be executed within the search results page. The above-described advertisement serving methods fail to account for this these additional user interactions which may provide further information about a user's interest.

In the light of the foregoing discussion, there is a need for dynamic listings in advertisements such as RAIDS advertisements that take user actions with a result page into account.

### SUMMARY

The above-mentioned needs are met by a method, computer program product and system for dynamic listings in advertisements that take user actions into account. For example, responsive to a web search, user interactions with embedded advertisements can be used to serve at least a portion of RAIS (Rich Ads In Search) advertisements.

In one embodiment, a first advertisement and a second advertisement are served responsive to a search query. User interactions with the query results, such as with the first advertisement, are detected and used as inputs to selecting at least a portion of the second advertisement. User actions can include a hover, a selection, a button selection, or the like.

In one embodiment, the second advertisement comprises a RAIS advertisement. Generally, a RAIS advertisement allows a user to view additional advertisement information within search results from the query. A first portion of the RAIS advertisement is displayed with initial search results. A second portion of the RAIS advertisement is selected responsive to the user interactions with search results, and displayed upon activation. The activated display can comprise, for example, a drop down menu, a table of products, a video or other media, a search box, or the like.

Advantageously, a user's actions with a result page can be used to improve click-through rates for online advertisements.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a flow chart illustrating a method for serving dynamic RAIS (Rich Advertisements In Search) advertisements responsive to user actions according to an embodiment.

FIG. 2 is a flow chart illustrating a method for selecting RAIS advertisements based on user actions according to an embodiment.

FIG. 3 is a flow chart illustrating a method for selecting RAIS advertisements based on user actions according to another embodiment.

FIG. 4 is a block diagram illustrating a system for serving dynamic RAIS advertisements based on user actions according to an embodiment.

FIG. 5 is a block diagram illustrating a computing device according to an embodiment.

FIG. 6 is a block diagram illustrating an ad server according to an embodiment.

FIG. 7 is a block diagram illustrating a RAIS ad module according to an embodiment.

### DETAILED DESCRIPTION

The above-mentioned needs are met by a method, computer program product and system for serving dynamic advertisements based on user actions. For example, a RAIS advertisement for the store Target can update sub-advertisements based on a user hovering over an advertisement for make-up. The following detailed description is intended to provide example implementations to one of ordinary skill in the art, and is not intended to limit the invention to the explicit disclosure, as one or ordinary skill in the art will understand that variations can be substituted that are within the scope of the invention as described.

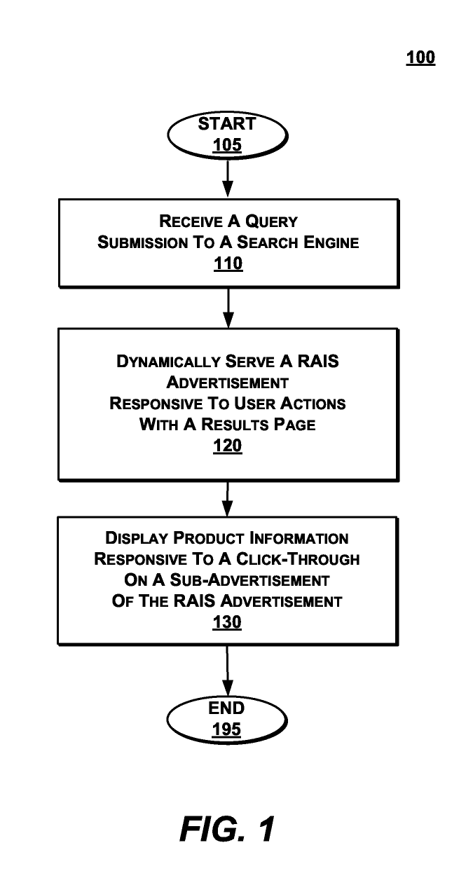

FIG. 1 is a flow chart illustrating a method for serving dynamic RAIS (Rich Advertisements In Search) advertisements responsive to user actions according to an embodiment.

At step 110, a query submission to a search engine is received. The query can be search terms, a request, a command, or any type of indication of a user request for information. Entry of the query can be via text, voice, facial gesture, a touch screen swipe, a button or drop-down box selection, or any other type user input from a keyboard, mouse, touch screen or the like.

In one example, a query is submitted to a search engine such as Yahoo! Search, Google, or Bing. In another example, a query is submitted as a search on a web site such as search for products on Amazon or a search for books on Barnes and Nobles.

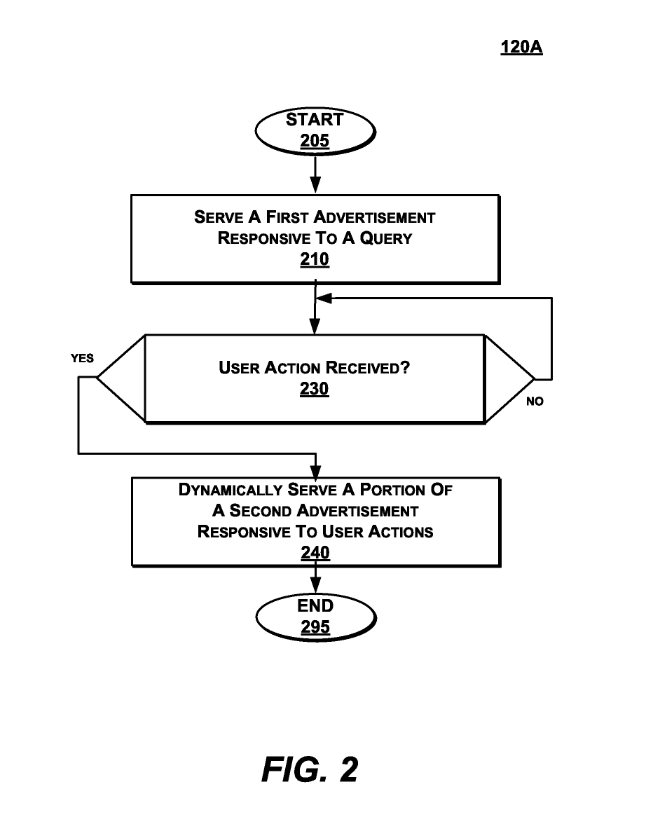

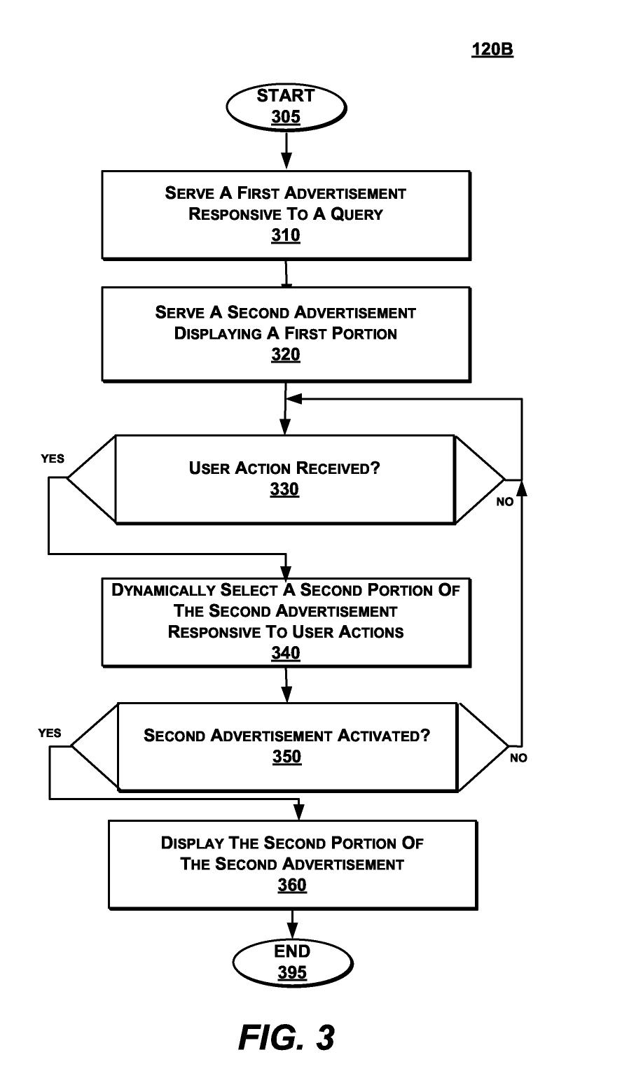

At step 120, a RAIS advertisement responsive to user actions is dynamically served with a results page, as described below with respect to FIGS. 2 and 3. Generally, a RAIS advertisement is served responsive to a search query submitted to a search engine. Rather than just text, in some embodiments, a RAIS advertisement includes ‘rich’ media such as images or video. A RAIS advertisement can be placed at the top of a web page displaying search results. The RAIS advertisement can be made to stand out from the search result with a highlighted box, bold or colored text, or any other type of formatting to draw attention. Additionally, some RAIS advertisements are expandable in that further information is available within the existing results web page. The additional information can be accessed by, for example, a drop down box, a play button for a video, or a ‘+’ signal which indicates more information is available.

In one embodiment, a second advertisement is served responsive to a user action with a first advertisement served. In another embodiment, a category of a second advertisement is displayed along with a first advertisement, while sub-advertisements of the category are selected and displayed responsive to a user action with a first advertisements. The dynamic aspect of the advertisement serving refers to the point between serving a first advertisement and activating the second advertisement in which the additional provided information can be changed based on user interactions.

At step 130, product information responsive to a click-through on a sub-advertisement of the RAIS advertisement is displayed. In one embodiment, the sub-advertisement can be nested within the RAIS advertisement. For example, a RAIS advertisement for Target can be expanded to show health and beauty products from, for example, Revlon, Avon and Aveda. Once a user selects one of the products, further information can be provided on a web page. A click-though can be a cursor-controlled selection or the like.

FIG. 2 is a flow chart illustrating an exemplary method 120A for selecting RAIS advertisements based on user actions according to an embodiment.

At step 210, a first advertisement is served responsive to a query submission. In one embodiment, a query for a web search is replicated as a query for a pool of advertisements. More specifically, metadata associated with advertisements is indexed and compared against the query for matches. Based on a design-specific ranking technique, a top ranked advertisement can be selected as the first advertisement.

A first advertisement can be served within a web page listing search results. For example, a sidebar can list advertisements or a moving advertisement can fly in from one side of a web page. A first advertisement can be an image, video, animation, sound bite, or the like. In some embodiments, when a cursor hovers over or clicks on an advertisement, an action occurs. The action can include activation of a drop-down menu. More than one advertisement can be listed.

In one embodiment, a first advertisement is selected in response to a query. For example, a query for fax can yield an e-mail to facsimile service advertisement.

At step 220, responsive to a user action, a portion of a second advertisement is served at step 230. The user action can be any type of user interaction with a results page for a query. For example, a user can hover over the facsimile service advertisement with a mouse, or even right-click for further information. In yet another example, a user selects a preview of one of the search results, or refines the first search for local results. In a further example, a user action occurs in another window or another tab within the current window.

In one embodiment, a second advertisement is a RAIS advertisement. A RAIS advertisement can have a first portion that is displayed with the search results and a second portion that is displayed upon activation, as described further with respect to FIG. 3.

FIG. 3 is a flow chart illustrating a method 120B for selecting RAIS advertisements based on user actions according to another embodiment.

At step 310 a first advertisement is served responsive to a query, as described above.

At step 320, a second advertisement displaying first portion is served. In one embodiment, RAIS advertisements have a first portion that is displayed on a search results page, and a second portion that is not displayed until activated. The first portion can be, for example, just a name of a store, while the second portion can be, for example, products or e-circular coupons. Further examples of first portions include a category of products, a location, or the like. The second portions generally include information that is more specific than the first portion. The second portion can be hidden in some implementations, and viewable in others.

At step 330, responsive to a received user action, at step 340, a second portion of the second advertisement is dynamically selected. Once the user action has been detected, the second portion is updated accordingly. The first advertisement interaction helps identify user interest relative to other advertisements available from the search query. Consequentially, the results page is static, but the potential second portion continues to change based on user interactions until activated.

At step 350, responsive to a second advertisement being activated, at step 360, the second portion of the second advertisement is displayed. The second advertisement can be activated as described above. The second portion then provides additional information for display on the same results page as previously displayed. In one embodiment, the search results are scrolled downwards on the web page to make room for the second portion. In another embodiment, the second portion is layered over the existing web page and active for cursor interaction.

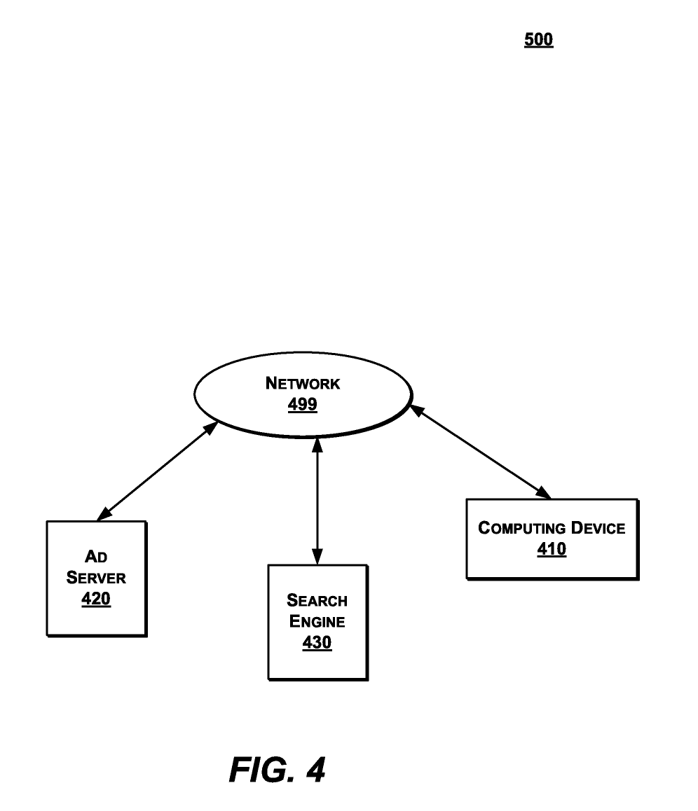

FIG. 4 is a block diagram illustrating a system 400 for serving dynamic RAIS advertisements based on user actions according to an embodiment. The system 400 includes a computing device 410, an ad server 420, and a search engine 430, coupled in communication through a network 499 (e.g., the Internet, a LAN, a WAN, a cellular network or any combination).

The computing device 410 can be, for example, a PC, a stationary computing device, a laptop or notebook computer, a tablet computer, a smart phone or PDA, a smart appliance, a video gaming console, an Internet television, a set-top box, or any other suitable processor-based device. There can be numerous computing devices 410 used by different users. In one embodiment, the computer device 410 allows a user to query search engines and view results pages that include advertisements. Additional embodiments of the computing device 410 are described in more detail below.

The ad server 420 can be one or more of any of the above processing-based devices. In one embodiment, the ad server 420 serves first and second advertisements as described herein.

The search engine 430 can be any of the above processing-based devices. In one embodiment, the search engine 430 provides search results responsive to queries. Further, the search engine 430 communicates with the ad server 420 to request and receive advertisements for display with search results. In some embodiments, the ad server 420 and the search engine 430 are hosted on a single device.

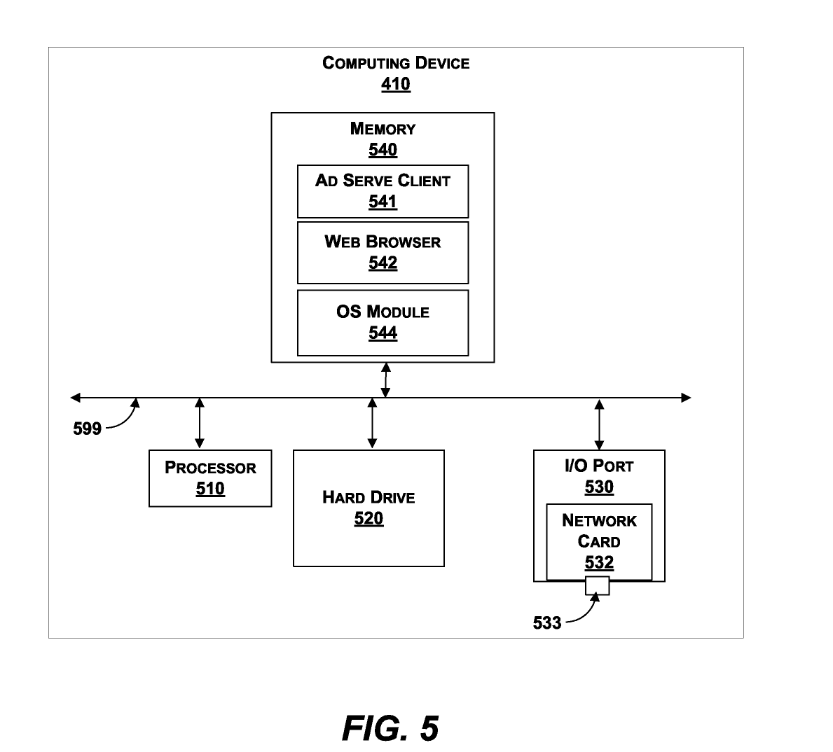

FIG. 5 is a block diagram illustrating a computing device according to an embodiment. The computing device 410 includes a processor 510, a hard drive 520, an I/O port 530, and a memory 540 coupled by a bus 599.

The bus 599 can be soldered to one or more motherboards. The processor 510 can be a general purpose processor, an application-specific integrated circuit (ASIC), an FPGA (Field Programmable Gate Array), a RISC (Reduced Instruction Set Controller) processor, an integrated circuit, or the like. There can be a single core, multiple cores, or more than one processor. In one embodiment, the processor 510 is specially suited for the processing demands of photograph sharing (e.g., custom micro-code, instruction fetching, pipelining or cache sizes). The processor 510 can be disposed on silicon or any other suitable material. In operation, the processor 510 can receive and execute instructions and data stored in the memory 540 or the hard drive 520. The hard drive 520 can be a platter-based storage device, a flash drive, an external drive, a persistent memory device, or any other type of memory.

The hard drive 520 provides persistent (i.e., long term) storage for instructions and data. The I/O port 520 is an input/output panel including a network card 522. The network card 522 can be, for example, a wired networking card (e.g., a USB card, or an IEEE 802.3 card), a wireless networking card (e.g., an IEEE 802.11 card, or a Bluetooth card), a cellular networking card (e.g., a 3G card). An interface 523 is configured according to networking compatibility. For example, a wired networking card includes a physical port to plug in a cord, and a wireless networking card includes an antennae. The network card 522 provides access to a communication channel on a network.

The memory 540 can be a RAM (Random Access Memory), a flash memory, a non-persistent memory device, or any other device capable of storing program instructions being executed. The memory 540 further comprises an ad serve client 541, a web browser 542, and an OS (operating system) module 544.

The ad serve client 541 can be a daemon running as a background process, a module within the web browser 542, a Java application, or the like. In one embodiment, the ad serve client 541 communicates with the ad server 420 to request and receive advertisements. The ad server 420 can also be configured to capture user actions and inform the ad server 420. In another embodiment, the ad server 420 manages display of the first and second advertisements, including detecting activation of a second portion of the second advertisement.

The web browser 542 can be a desktop web browser (e.g., Internet Explorer, Mozilla, or Chrome), a mobile browser, or a web viewer built integrated into an application program. In an embodiment, a user accesses a system on the World Wide Web (WWW) through a network such as the Internet. The web browser 542 is used to download web pages or other content in various formats including HTML, XML, text, PDF, and postscript, and may be used to upload information to other parts of the system. The web browser 642 may use URLs to identify resources on the web and HTTP (HyperText Transfer Protocol) in transferring files on the web. In one embodiment, the web browser 542 provides a user interface for viewing web pages.

The OS module 544 can be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64.

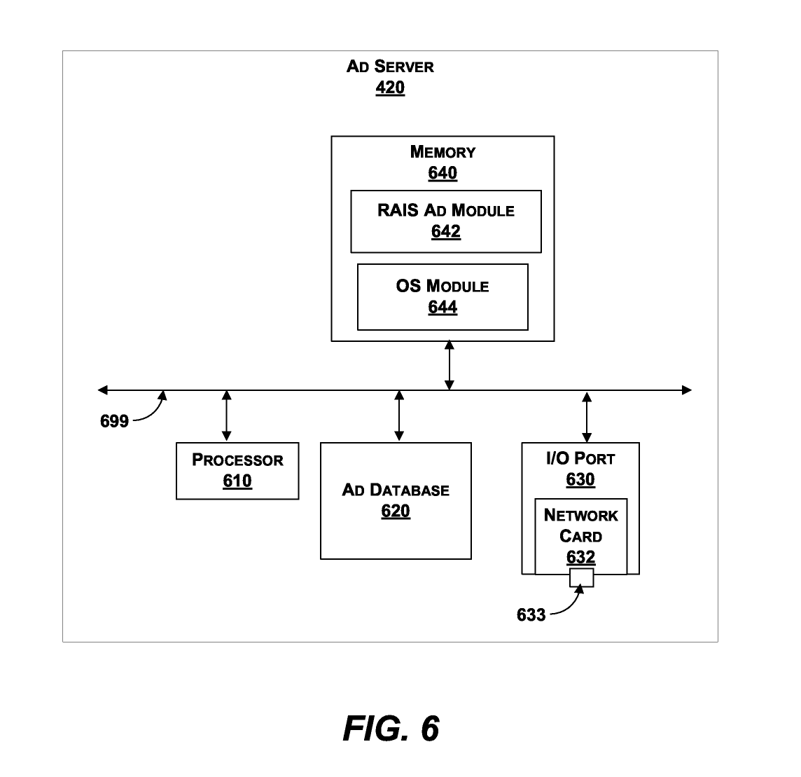

FIG. 6 is a block diagram illustrating an ad server according to an embodiment. The ad server 420 includes a processor 610, an ad database 620, an I/O port 630, and a memory 640, coupled by a bus 699. The processor 610, a hard drive 620, and the I/O port 630 can be configured as described above with respect to FIG. 5. The ad database 620 stores a pool of advertisements that are pre-loaded and subsequently updated.

The memory 640 comprises an OS module 644, as described above, along with a RAIS ad module 642. The RAIS ad module 642, in one embodiment, communicates with the computing device 410 to provide advertisements. RAIS ad module 642 is described in more detail below.

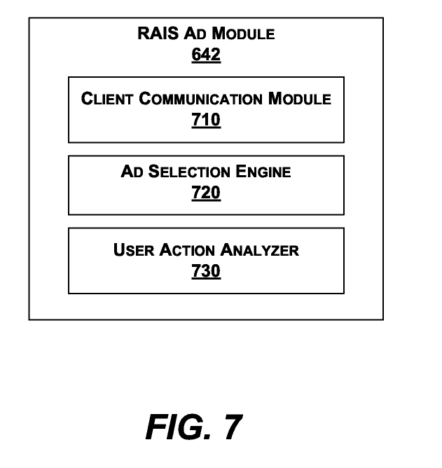

FIG. 7 is a block diagram illustrating a RAIS ad module 642 according to an embodiment. The photograph sharing module 642 includes a client communication module 710, an ad selection engine 720 and a user action analyzer 730. The components can communicate with each other through, for example, APIs (Application Programming Interfaces). In other embodiments, all or parts of the components can be implemented in hardware or benefit from special hardware accelerators.

In one embodiment, the client communication module 710 sends and receives information from the computing device 410 of FIG. 4 using APIs transported within network packets. The ad selection engine 720 implements design-specific algorithms to select first and second advertisements, including first and second portions, for display. The user action analyzer 730 can communicate with a user action detector located at a client to input user actions to the ad selection engine 720.

As described herein, computer software products may be written in any of various suitable programming languages, such as C, C++, C#, Pascal, Fortran, Perl, Matlab (from MathWorks), SAS, SPSS, JavaScript, AJAX, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems). Many of the functionalities described herein can be implemented in computer software, computer hardware, or a combination.

Furthermore, the computer that is running the previously mentioned computer software may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A computer-implemented method for dynamic advertisements, comprising:
receiving a query submitted to a search engine using a computer system;
serving a first advertisement responsive to the query;
receiving at least one captured user action associated with the first advertisement; and
serving at least a second portion of a second advertisement responsive to the at least one user action, the second advertisement comprising a first portion and a second portion.

2. The method of claim 1, wherein
serving the first portion of the second advertisement prior to receiving the at least one captured user action;
serving the second portion of the second advertisement subsequent to receiving the at least one captured user action.

3. The method of claim 1, further comprising:
serving the first portion of the second advertisement responsive to the query.

4. The method of claim 1, further comprising:
displaying the first and second advertisements within a search results page that includes search results responsive to the query.

5. The method of claim 1, further comprising:
displaying the first advertisement and the first portion of the second advertisement responsive to the query;
detecting a user action concerning the second advertisement; and
displaying the second portion of the second advertisement responsive to the user action concerning the second advertisement.

6. The method of claim 1, wherein the at least one user action comprises at least one of a mouse over, a button selection, a checkbox selection, a text entry, a vocal message, message content, a cursor action, and a facial gesture.

7. A computer program product stored on a non-transitory computer-readable medium that when executed by a processor, performs a method for dynamic advertisements, comprising:
receiving a query submitted to a search engine using a computer system;
serving a first advertisement responsive to the query;
receiving at least one captured user action associated with the first advertisement; and
serving at least a second portion of a second advertisement responsive to the at least one user action, the second advertisement comprising a first portion and a second portion.

8. The computer program product of claim 7, wherein
serving the first portion of the second advertisement prior to receiving the at least one captured user action;
serving the second portion of the second advertisement subsequent to receiving the at least one captured user action.

9. The computer program product of claim 7, further comprising:
serving the first portion of the second advertisement responsive to the query.

10. The computer program product of claim 7, further comprising:
displaying the first and second advertisements within a search results page that includes search results responsive to the query.

11. The computer program product of claim 7, further comprising:
displaying the first advertisement and the first portion of the second advertisement responsive to the query;
detecting a user action concerning the second advertisement; and
displaying the second portion of the second advertisement responsive to the user action concerning the second advertisement.

12. The computer program product of claim 7, wherein the at least one user action comprises at least one of a mouse over, a button selection, a checkbox selection, a text entry, a vocal message, message content, a cursor action, and a facial gesture.

13. A computer system for dynamic advertisements, comprising:
a client communication module, within a computer server, to receive a query submitted to a search engine using a computer system;
an ad selection engine, coupled in communication with the client communication module, the ad section engine serving a first advertisement responsive to the query; and
a user action analyzer, coupled in communication with the ad selection engine, the user action analyzer receiving at least one captured user action associated with the first advertisement,
wherein the ad selection engine serves at least a second portion of a second advertisement responsive to the at least one user action, the second advertisement comprising a first portion and a second portion.

14. The system of claim 13, wherein the ad selection engine:
serves the first portion of the second advertisement prior to receiving the at least one captured user action, and
serves the second portion of the second advertisement subsequent to receiving the at least one captured user action.

15. The system of claim 13, wherein the ad selection engine:
serves the first portion of the second advertisement responsive to the query.

16. The system of claim 13, further comprising:
a client, coupled in communication with the client communication module, the client displaying the first and second advertisements within a search results page that includes search results responsive to the query.

17. The system of claim 13, further comprising:
a client, coupled in communication with the client communication module, the client:
displaying the first advertisement and the first portion of the second advertisement responsive to the query,
detecting a user action concerning the second advertisement, and
displaying the second portion of the second advertisement responsive to the user action concerning the second advertisement.

18. The system of claim 13, wherein the at least one user action comprises at least one of a mouse over, a button selection, a checkbox selection, a text entry, a vocal message, message content, a cursor action, and a facial gesture.
